(19) United States
(12) Patent Application Publication
(10) Pub. No.: US 2006/0200645 A1
(43) Pub. Date: Sep. 7, 2006

(54) Apparatus and method for employing cloning for software development

(76) Inventor: Pankaj Kumar, Staten Island, NY (US)

Correspondence Address: HOFFMANN & BARON, LLP, 6900 JERICHO TURNPIKE, SYOSSET, NY, 11791, US

(21) Appl. No.: 11/073,784

(22) Filed: Mar. 7, 2005

(51) Int. Cl. G06F 15/00

(52) U.S. Cl. 712/1

(57) ABSTRACT

The present invention provides a method and apparatus for employing cloning for creating hierarchies of artifacts needed for development of software. The present invention also applies to managing cloning for the maintenance and modification of software artifacts including tracking and propagating the changes to the artifacts. In accordance with the present invention, cloning is applied to create new artifacts.

### FIELD OF THE INVENTION

The present invention is related to design, development and management of software, more particularly, employing of cloning to create software artifact and their hierarchies and to manage reuse.

### BACKGROUND OF THE INVENTION

The most widely used method for software development is the “Waterfall Model” or some derivation of it. Generally speaking, in this model, the software development goes through several phases. First is the Requirements Phase. In this phase the system requirements are identified and analyzed. The input to this phase is a business need or a document describing the requirements at the conceptual level. The output of this phase is a detailed requirements specification document. Second phase is the Design Phase. The input to this phase is the requirements specification document. In this phase, first the architectural design takes place, which breaks the software into artifacts and then the detailed artifact level design takes place. The output of this phase is the detailed design specification document. Third, is the Development Phase. The input to this phase is the design specification document. In this phase, the artifacts in the form of source code are created using chosen programming language, debugged, and tested (unit testing). The output of this phase are executable software artifact(s). Fourth phase is Integration and Testing. The input to this phase are the executable software artifacts. In this phase, the individual artifacts are integrated and tested (integration/system testing). The output of this phase is a certified executable integrated software product. The fifth and final phase is Deployment. In this phase, the software is deployed.

There are two fundamental problems with the current software development methodologies. The first problem is the need to fix requirements before design phase. This need stems from the fact that an optimal design cannot be created until all the requirements are known. In general, it is very difficult to specify all the requirements in detail and freeze them before design phase. Attempts to do so make the requirements phase very long. Also, it seems that a lot of requirements come into existence only when the user sees or starts using the system. Changing the requirements after the design phase is very difficult. Software development must again go through the design phase to accommodate any new requirements or modification. This in turn shifts the time line of all the subsequent phases, implying that the software cannot be delivered on time. Thus, very often by the time the software is deployed either it is much behind the planned schedule or does not meet the expectations of the user because the new requirements were not incorporated.

The second problem pertains to reuse where goal is to minimize creation of new software artifacts, i.e. maximize reuse. Any new artifact that is developed must go through all the phases of design, coding, and testing. Time required to develop the software can be considerably reduced if software artifacts from previously implemented software can be reused as is. Reusing an existing software artifact implies that that artifact does not need to go through the design, coding, and testing phases. To be able to reuse previously developed artifacts places extra burden on the design phase to not only integrate the current requirements with the one or more previously implemented requirements, but also to design the artifacts such that they can be reused by future requirements. This is a very tedious and time consuming process requiring very skilled and experienced software developers, which are not only expensive but also in short supply.

The impact of both of the above discussed steps is increase in the software development cycle time, which not only increases the cost, but by the time the software is deployed often the requirements have changed thus making the software unusable.

Clearly, as discussed above, developing new software or extending existing one continues to be time consuming and expensive. It was hoped that object-oriented or object based software development tools with the promise of promoting software reuse would help solve the problem. However, to a large extent the problem continues to exist as enterprises struggle to meet their ever increasing software development needs. There are several reasons for the problem to exist. First, once the object hierarchies in the object oriented or object based software development methodology has been fixed, it is not easy to change them. Hence, reuse of existing software for future requirements becomes difficult without readjusting the hierarchies to meet the new requirements. Second, there is a very strong emphasis to minimize the lines of code. As a result, there is a strong tendency to extend the existing artifacts with new functionality rather than creating new artifacts. This leads to overcrowding of the logic in the artifacts. As a result, very soon it becomes time consuming to make any changes to these overloaded artifacts because of the complicated design and extensive testing. Third, most enterprise applications tend to be distributed in nature. The reason for this is that any enterprise itself tends to be distributed in nature e.g. it may consist of multiple sales offices, manufacturing units, warehouses, development centers, and other operational centers that are usually not in one central place. Object oriented or object based technology is not very well suited to distributed environment. Finally, based on today's software development methodologies, the software reuse is often requires making changes to artifacts owned by another organization or team or individual. In this case, the changes must first be agreed by the owner of the artifact. This often adds significant time to the development process.

The search for reducing the time and cost associated with different stages of software application life cycle has led many organizations to adopt new software development technologies such as RAD (Rapid Application Development), Object-Oriented development tools, Components based software development, Web Services, programming environment Java, etc. These methods and tools have provided some improvements but overall costs associated with the design, development, deployment, and management of software still remains high.

The general solution to the above mentioned problems is to first organize the artifacts hierarchically such that the hierarchies resembles the functional organizational structure of the overall software and then performing reuse of the hierarchies of artifacts rather than just individual artifacts.

### SUMMARY OF THE INVENTION

The present invention provides an apparatus and a method for developing software by employing cloning to create and manage hierarchies of software artifacts such that reuse is maximized and the future changes to a cloned artifact can be tracked and propagated to other clones of that artifact. To allow for maximal number of artifacts to be reused by cloning the method includes a dynamic scheme for keeping the artifacts arranged at all times in a hierarchical tree like manner and employing a hierarchical naming scheme such that each artifact is uniquely identified across all the hierarchies. On receiving a request for the implementation of a new software with certain new requirements, the method starts by identifying (using an artifact and hierarchy browser) hierarchies of artifacts of one or more existing software to be used for developing the new software, and then, cloning the identified hierarchies and their artifacts (using an artifact and hierarchy cloner) such that the cloned hierarchies and their artifacts form a new hierarchical branch representing the software to be implemented. The method further includes selecting the cloned artifacts to be modified based on the new requirements and modifying the selected cloned artifacts (using an artifact dependent editor) to meet the new requirements.

The invention further provides a method for managing clones of an artifact as a family and tracking changes to them for propagation to family members and future artifact development and maintenance. The method includes further searching the family to identify all other of the cloned artifacts upon modification of any of the artifacts in the family. The method preferably includes selecting at least one of the identified other cloned artifacts and applying the modification to the selected other cloned artifacts. The method may also desirably include either applying the modification to the identified all other of the cloned artifacts or rejecting the modification to the identified all other of the cloned artifacts. Finally, the method additionally may also include editing the identified all other of the cloned artifacts.

### BRIEF DESCRIPTION OF THE DRAWINGS

FIG. 1 is a block diagram illustrating a system architecture in accordance with the present invention.

FIG. 2 is a flow diagram illustrating process flow in accordance with the present invention.

FIG. 3 illustrates process of creating new artifacts using cloning.

FIG. 4 illustrates a typical example of dividing the artifacts and its reuse for optimization of source code artifacts.

### DETAILED DESCRIPTION OF THE INVENTION

The present invention provides a method and apparatus for design, development and deployment of software quickly and cheaply. The proposed invention also applies to the maintenance and modification of software to meet any new requirements. In accordance with the present invention, new software is created by cloning hierarchies of existing artifacts and modifying them to meet the requirements of software being implemented. One of the most important features of the proposed cloning based method, as will be discussed below, is the ability to keep the cloned artifacts up to date by propagating changes to artifacts from one clone to another by generating prompts to the user.

Before we discuss the details of the invention, it is important to note that an “artifact” is a general term used through the application to refer to one or more classes, objects, subprograms, procedures, subroutines, functions, co-routines, methods, components, or even another program. Note that each artifact is composed of a set of components such as lines, text, paragraphs, sections, chapters, figures, drawings, tables, etc. The artifact could also compose of statements, variable names, identifiers, etc. i.e. domain dependent components.

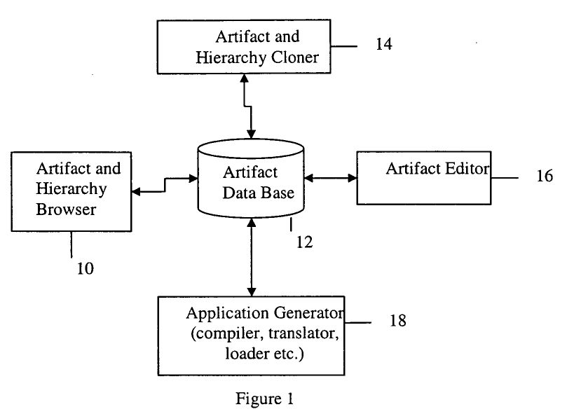

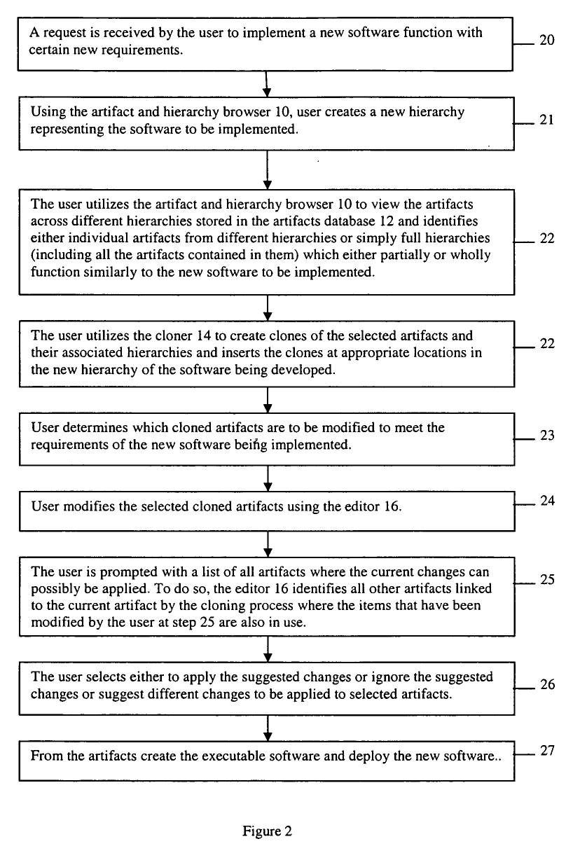

FIG. 1, is a high level block diagram of a system architecture in accordance with the present invention. The main function of this system is to create and manage hierarchies of artifacts by cloning. Referring to FIG. 1, a browser 10 will be utilized by the user to browse and view all the artifacts across different hierarchies stored in an artifact database 12. Additionally, the user will select either individual artifacts from different hierarchies or simply full hierarchies including all the artifacts contained in them as will be described in greater detail below with reference to FIG. 2. Upon user's selection of the artifacts, an artifact cloner 14 will make a clone of each selected artifact, put the clones at an appropriate place either in a existing hierarchy or a new hierarchy as specified by the user, and change the name of clone to reflect their new hierarchical location. The cloner 14 will further either establish membership of each clone in the artifact family associated with these original artifact or start a new family if one doesn't exist. An artifact editor 16 will allow the user to modify the cloned artifacts or simply create a new artifact from scratch. Upon modifying an artifact, the artifact editor 16 further searches in the artifact's clone families to identify all other artifacts where the modified components such as words, lines, etc. of the current artifact are also in use. The artifact editor 16 then prompts the user with the cloned artifacts where the current modifications can be applied. User could choose to apply the suggested changes or ignore the suggested changes or suggest different changes to be applied. A software generator 18 serves as a compiler, translator, loader etc. needed for converting the appropriate software artifacts into executable code that can be deployed and run on any target computer.

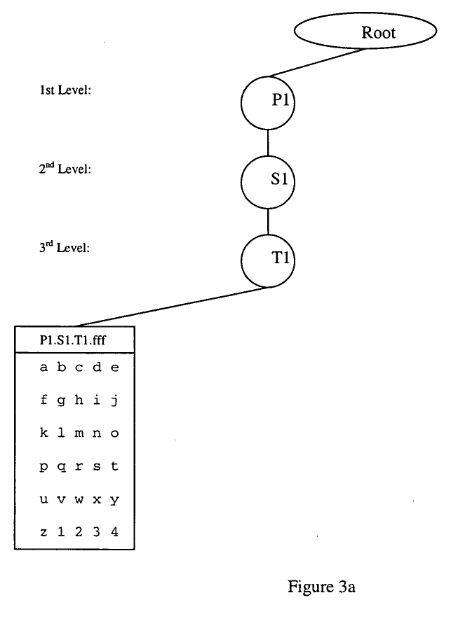

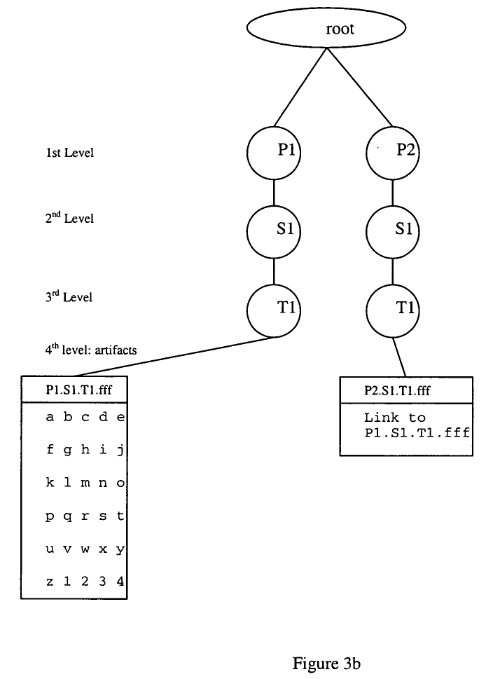

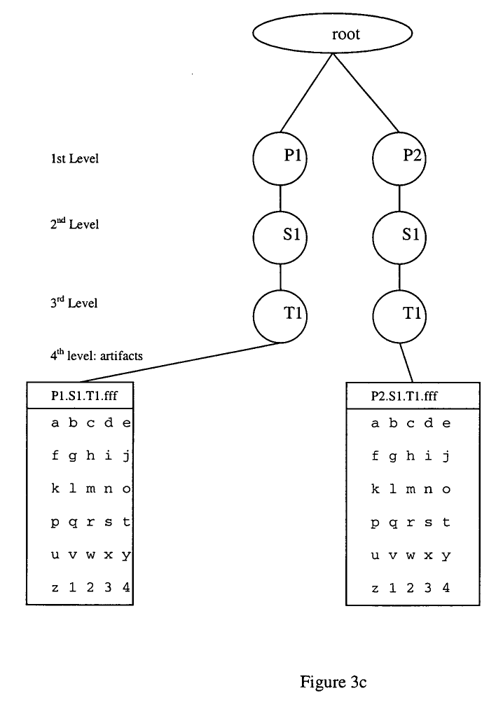

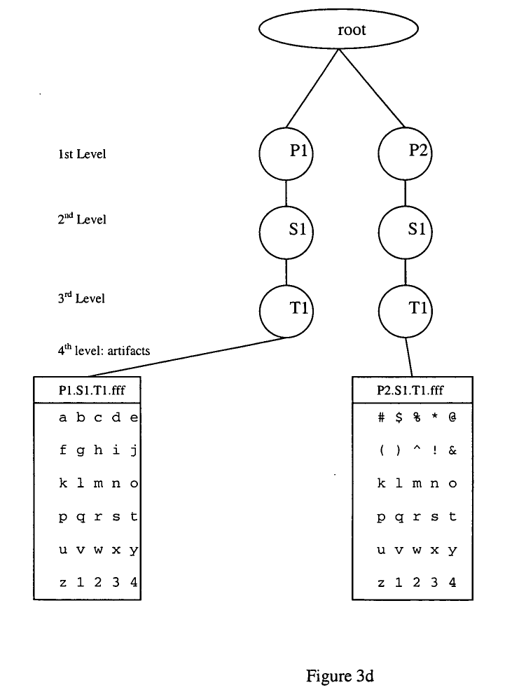

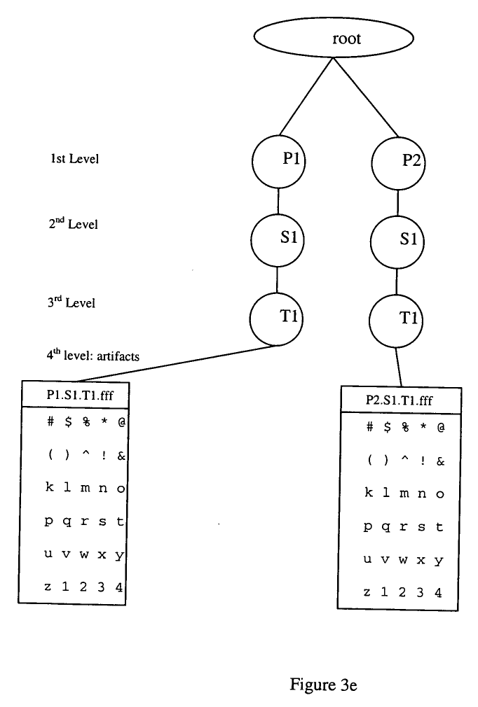

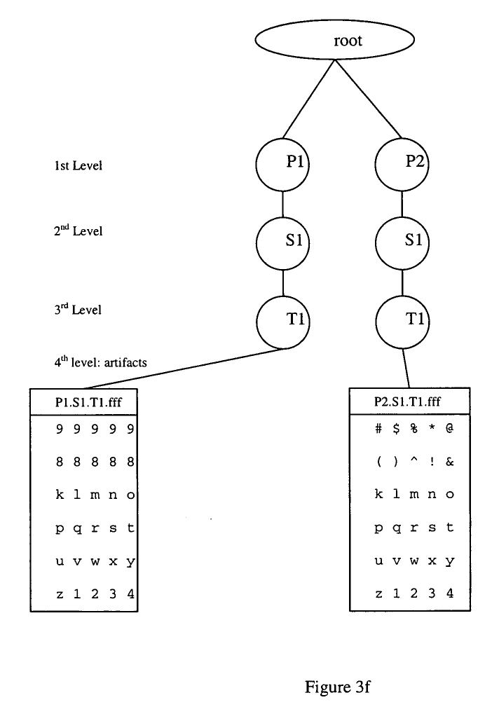

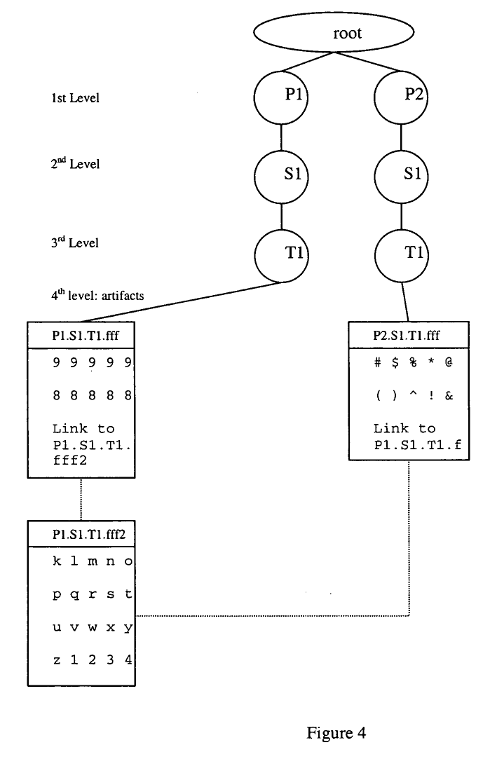

Referring to FIG. 2, there is shown a flow chart illustrating a broad operation process flow in accordance with the current invention. In step 20, a request is received by the user to implement a new software function with certain new requirements. At step 21, using the artifact and hierarchy browser 10, user creates a new hierarchy representing the software to be implemented. This newly created hierarchy will be used for storing the artifacts associated with the software to be implemented. At step 22, the user utilizes the artifact and hierarchy browser 10 to view the artifacts across different hierarchies stored in the artifacts database 12 and identifies either individual artifacts from different hierarchies or simply full hierarchies (including all the artifacts contained in them) to be used for implementing the new software. At step 23, the user utilizes the cloner 14 to create clones of the selected artifacts and their associated hierarchies and inserts the clones at appropriate locations in the new hierarchy of the software being developed. When creating clones, the cloner 14 will assign a new name to each cloned artifact based on its location in the new hierarchy such that newly created clones will have unique name across all the hierarchy. At step 23, the cloner actually creates a virtual copy of the artifacts and stores them in the artifact database 12. Virtual copy is simply a link having the new name but actually refers to the original artifact. Later on, two optimization methods namely artifact splitting and copy-on-change will be discussed later with reference to FIGS. 3 and 4 to show how number of physical clones of artifacts are minimized. At step 24, user determines which cloned artifacts are to be modified to meet the requirements of the new software being implemented. At step 25, user modifies the selected cloned artifacts using the editor 16. At the time of modification, the editor 16 replaces the virtual copy of the artifact with a physical copy of the original artifact. All future changes are applied to the cloned artifact's personal copy not affecting the original artifact. At step 26, editor 16 identifies all other artifacts linked to the current artifact by the cloning process where the artifact components that have been modified by the user at step 25 are also in use. The editor 16, prompts the user with a list of all such artifacts where the current changes can possibly be applied. At step 27, the user selects either to apply the suggested changes or ignore the suggested changes or suggest different changes to be applied to selected artifacts.

Finally, at step 28, several steps are performed by the application generator 18 for the development of the new software. Such steps preferably include compiling, debugging, testing and deploying the new software.

During compilation of the new software, it is highly optimal to both minimize the size of the executable program code and to minimize user integration. The present invention provides such an optimization as is described in greater detail below.

Referring to FIG. 3a is shown a typical example of a hierarchy including its artifact. Assume the artifact P1.S1.T1.FFF arranged in the hierarchy shown in FIG. 3a already exists.

P, S, and T are nodes of the hierarchy at the first level, second level, and third level respectively. The above hierarchical scheme leads to a “forest” consisting of multiple trees connected by a virtual root as will become evident below. It is noted that only three levels are shown as an example in the figure, however, one may have only one or any number of levels. Moreover, only one artifact of a specific type is shown in FIG. 3a to simplify the ease of depiction of the invention, however, the invention may include any number of artifacts and any type of artifacts as defined above.

We now want to create a new software P2 by cloning the hierarchy at P1. This results in a new hierarchy called P2 and a virtual clone of artifact P1.S1.T1.fff as shown below in FIG. 3b. Virtual clones are artifacts that have not been modified, i.e., are identical to their original. Virtual artifacts have a new name, but are internally linked to the original artifact, thus minimizing the number of physical artifacts as well as the size of the executable software. Note that virtual clone is named as P2.S1.T1.fff. This name is different from its parent but allows the hierarchy of P1 to be maintained under P2. However, the user can freely modify P2.S1.T1.fff at any time during the development of current software and later on as desired.

Now assume user modifies the virtual cloned artifact P2.S1.T1.fff as shown in FIG. 3b. Using the Copy-On-Change principle, a physical copy of the parent artifact P1.S1.T1.fff is created under P2.S1.T1.fff as shown in FIG. 3c and from this point onwards all the changes to P2.S1.T1.fff are applied to its own physical copy as shown in FIG. 3d.

At this point, upon modification of cloned artifacts P2.S1.T1.fff, the user is prompted that the line 1 (a, b, c, d, e) and line 2 (f, g, h, i, j) of artifact P2.S1.T1.fff in FIG. 3d are also in use by artifact P1.S1.T1.fff. In general, user will be prompted by a list of all artifacts belonging to the clone family where lines 1 and 2 are in use. User has three options:
Apply the modifications to artifact P1.S1.T1.fff as shown in FIG. 3e.
Ignore the current modification and apply a different set of modifications to P1.S1.T1.fff as shown in FIG. 3f.
Leave P1.S1.T1.fff unchanged i.e. do not apply any modifications to it as shown in FIG. 3d.

Number of physical artifacts and especially the size of the resulting executable code can be further minimized by splitting the artifacts upon modification. If the difference between the modified cloned artifact and its original artifact is less than χ% then the clone and the original artifacts are divided into two or more artifacts such that the unchanged components are contained in separate artifacts which can be linked using the method described above with reference to cloned artifacts that are not modified. Note that the value of χ is user dependent and may change from one environment to another and also will depend upon the type of artifacts. The artifacts are divided such that the functionality is retained. In order to divide the artifacts into two or more artifacts, the components for each target artifact are identified and those components are inserted in the new target artifacts. The artifacts are then linked in appropriate manner identified.

A simple example of dividing the artifacts into two or more artifacts is shown in FIG. 4. Here the cloned artifact P2.S1.T1.fff is modified due to the new requirements of the new software. Note that the cloned module distinguishes from original artifact P1.S1.T1.fff only on the first two lines of data. The original artifact P1.S1.T1.fff is divided into two separate artifacts P1.S1.T1.fff including changed lines 1 and 2 and into P1.S1.T1.fff2 includes unchanged lines 3 to 20 of P1.S1.T1.fff. The P2.S1.T1.fff is also split into artifact P2.S1.T1.fff and another artifact linked to P1.S1.T1.fff such that P2.S1.T1.fff includes the changed lines 1 and 2.

For the cloning based method described above to produce optimal results, software artifacts must be structured in such a way that new of additional requirements can be implemented by cloning entire family of software programs rather than just few artifacts. The present invention also provides a method for managing the clones. The original artifact and all its clone artifacts are linked together to form a artifact family i.e., each artifact has a family of artifacts associated with it. If the artifact is not a clone or has not been cloned then the family will consist of a single artifact. When some artifact X is modified, then for each change all other artifacts belonging to its family are identified as to where that change is applicable. The identified artifacts are presented to the user. The user can then decide to reject the change, apply the change to all the identified artifacts or apply to change only the selected identified artifacts. Furthermore, a change in artifact X may preferably be applicable to some other artifact Y only if before the change, the changed components were identical in both X and Y.

The software artifacts such as requirements, program artifacts, components, classes, methods, functions, procedures, structure definition, test plans, test cases, scripts, user guide and manuals, and other documentation are organized hierarchically such that it resembles the functional organizational structure of an overall software.

Modifying the Cloned Artifacts:

Any time components of an artifact are modified, we need to identify all other artifacts in its family such that the modified components are in use by those identified artifacts. The user is prompted with a list of identified artifacts. User can do one of the following:
i. Select one or more items and apply the changes for these selected items to the original artifact i.e. propagate the changes to the original artifact. Note that this is now a recursive process. Since, the items in the original artifact are being modified then the same process is repeated for its original and so on.
ii. Simply ignore the changes.
iii. Modify the original artifact with different set of changes.

Thus, every time an artifact is changed, the changes are propagated to all the artifacts that are linked to it. This propagation of changes is crucial for the software maintenance. Note that the modification can automatically be applied to the identified artifacts (cloned or original) or allowing the user to select the artifacts where the modifications are to be applied.

Furthermore, the present invention provides a means to keep track of the changes in the cloned artifact. Changes to the cloned artifact can be tracked at several levels. In the case of text document the changes can tracked at section level, paragraph level, sentence level, line level, word level, and finally single character level. In the case of source code the changes can be tracked at function, procedure, structure, class level, method level, statement level, expression level, identifier level, and other programming language structures.

As discussed in detail above, by using the virtual artifacts and “Copy on Change” method, the number of physical copies created is to only those artifacts that have been modified. This is useful especially when entire product tree has been cloned and only very few artifacts need to change. Further optimization of source code artifacts is possible by splitting the artifacts into two or more artifacts as shown as described above with references to FIG. 4.

While the invention has been described in relation to the preferred embodiments with several examples, it will be understood by those skilled in the art that various changes may be made without deviating from the spirit and scope of the invention as defined in the appended claims.

1. A method for employing cloning for development of artifacts, said artifacts arranged in a hierarchical tree, the method comprising:
receiving request for creation of at least one new software artifact with certain new requirements wherein each of said hierarchy of artifact is uniquely identified across all said hierarchies;
identifying at least one said hierarchy of artifact of existing software artifact to be used for the new software artifacts;
cloning said identified hierarchy of artifact such that said identified hierarchy of artifacts form a new hierarchical branch representing said new software;
selecting the cloned hierarchy of artifact to be modified based on the new requirements;
modifying the selected cloned hierarchy of artifact to meet the new requirements.

2. The method of claim 1 further comprising:
converting the cloned hierarchy of artifacts into executable code.

3. The method of claim 1 wherein said hierarchy of artifact is an individual artifact.

4. The method of claim 1 wherein said hierarchy of artifact is a set of artifacts.

5. The method of claim 1 further comprising:
creating a family of the artifacts including an original artifact and all its corresponding cloned artifacts.

6. The method of claim 5 further comprising:
creating a new hierarchy of artifact for the new software, wherein said new hierarchy of artifact leads to a new artifact family and said new artifact family is the original of the family.

7. The method of claim 6 further comprising:
linking the cloned hierarchy of artifacts to its artifact family.

8. The method of claim 1 wherein said modifying step includes:
editing at least one component in said selected cloned hierarchy of artifact.

9. The method of claim 8 further comprising:
identifying the clones in the family using said edited components.

10. A computer-readable medium having computer-executable instructions for performing the method of claim 1.

11. A method for managing cloning for artifact development, the method comprising:
providing at least one family of cloned artifacts wherein each family belongs to at least one said artifact; and
searching said family to identify all other of the cloned artifacts upon modification of any of the artifacts in the family.

12. The method of claim 11 further comprising:
selecting at least one of said identified other cloned artifacts; and
applying the modification to said selected other cloned artifacts.

13. The method of claim 11 further comprising:
applying the modification to said identified all other of the cloned artifacts.

14. The method of claim 11 further comprising:
rejecting the modification to said identified all other of the cloned artifacts.

15. The method of claim 11 further comprising:
editing said identified all other of the cloned artifacts.

16. A computer-readable medium having computer-executable instructions for performing the method of claim 11.

17. An apparatus for employing cloning for development of artifacts said artifacts arranged in a hierarchical tree, the apparatus comprising:
a browser for allowing the user to identify at least one hierarchy of artifact of existing software to be used for development of at least one new software artifact, said new software artifact includes a set of new requirements and each of said artifact is uniquely identified across all said hierarchies;
a cloner for cloning said identified hierarchy of artifacts such that said identified hierarchy of artifacts form a new hierarchical branch representing said new software; and
an editor for modifying only the cloned hierarchy of artifacts selected based on the new requirements.

18. The apparatus of claim 17 wherein said hierarchy of artifact is an individual artifact.

19. The apparatus of claim 17 wherein said hierarchy of artifact is a set of artifacts.

20. The apparatus of claim 19 further includes an artifact database for storing the hierarchy of artifacts and the hierarchy of artifact family.

21. The apparatus for claim 17 further includes an application generator for converting the cloned hierarchy of artifacts into executable code.
